(19) United States
(12) Patent Application Publication
(10) Pub. No.: US 2014/0195672 A1
(43) Pub. Date: Jul. 10, 2014

(54) AUTOMATED FAILURE HANDLING THROUGH ISOLATION

(71) Applicant: MICROSOFT CORPORATION, Redmond, WA (US)

(72) Inventors: Srikanth Raghavan, Sammamish, WA (US); Abhishek Singh, Redmond, WA (US); Chandan Aggarwal, Seattle, WA (US); Fatima Ijaz, Redmond, WA (US); Asad Yaqoob, Redmond, WA (US); Joshua McKone, Bothell, WA (US); Ajay Mani, Woodinville, WA (US); Matthew Jeremiah Eason, Sammamish, WA (US); Muhammad Mannan Saleem, Kirkland, WA (US)

(73) Assignee: Microsoft Corporation, Redmond, WA (US)

(21) Appl. No.: 13/737,822

(22) Filed: Jan. 9, 2013

(51) Int. Cl. H04L 29/08

(52) U.S. Cl. CPC H04L 29/08099
USPC 709/224

(57) ABSTRACT

Embodiments are directed to isolating a cloud computing node using network- or some other type of isolation. In one scenario, a computer system determines that a cloud computing node is no longer responding to monitoring requests. The computer system isolates the determined cloud computing node to ensure that software programs running on the determined cloud computing node are no longer effectual (either the programs no longer produce outputs, or those outputs are not allowed to be transmitted). The computer system also notifies various entities that the determined cloud computing node has been isolated. The node may be isolated by powering the node down, by preventing the node from transmitting and/or receiving data, and by manually isolating the node. In some cases, isolating the node by preventing the node from transmitting and/or receiving data includes deactivating network switch ports used by the determined cloud computing node for data communication.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to interact with other software applications or other computer systems. These software applications are designed to be robust, and may continue performing their intended duties, even when they are producing errors. As such, the application may be responding to requests, but still be in a faulty state.

### BRIEF SUMMARY

Embodiments described herein are directed to isolating a cloud computing node using network- or some other type of isolation. In one embodiment, a computer system determines that a cloud computing node is no longer responding to monitoring requests. The computer system isolates the determined cloud computing node to ensure that software programs running on the determined cloud computing node are no longer effectual (either the programs no longer produce outputs, or those outputs are not allowed to be transmitted). The computer system also notifies various entities that the determined cloud computing node has been isolated. The node may be isolated in a variety of different ways including, but not limited to, powering the node down, preventing the node from transmitting and/or receiving data, and manually isolating the node (which may include physically altering the node in some way). In some cases, isolating the node by preventing the node from transmitting and/or receiving data includes deactivating network switch ports used by the determined cloud computing node for data communication.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including isolating a cloud computing node.

FIG. 2 illustrates a flowchart of an example method for isolating a cloud computing node.

FIG. 3 illustrates a flowchart of an example method for isolating a cloud computing node using network-based isolation.

FIG. 4 illustrates an alternative computing architecture in which cloud computing nodes may be isolated.

### DETAILED DESCRIPTION

Embodiments described herein are directed to isolating a cloud computing node using network- or some other type of isolation. In one embodiment, a computer system determines that a cloud computing node is no longer responding to monitoring requests. The computer system isolates the determined cloud computing node to ensure that software programs running on the determined cloud computing node are no longer effectual (either the programs no longer produce outputs, or those outputs are not allowed to be transmitted). The computer system also notifies various entities that the determined cloud computing node has been isolated. The node may be isolated in a variety of different ways including, but not limited to, powering the node down, preventing the node from transmitting and/or receiving data, and manually isolating the node (which may include physically altering the node in some way). In some cases, isolating the node by preventing the node from transmitting and/or receiving data includes deactivating network switch ports used by the determined cloud computing node for data communication.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

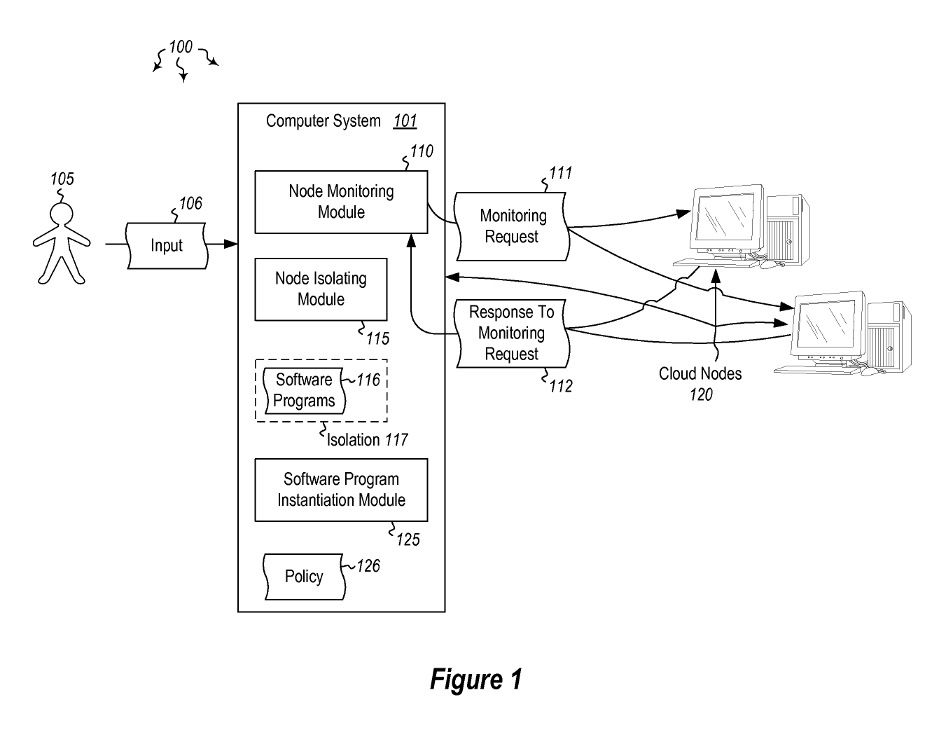

FIG. 1 illustrates a computer architecture 100 in which at least one embodiment may be employed. Computer architecture 100 includes computer system 101. Computer system 101 may be any type of local or distributed computer system, including a cloud computing system. The computer system includes various modules for performing a variety of different functions. For instance, the node monitoring module 110 may monitor cloud nodes 120. The cloud nodes 120 may be part of a public cloud, a private cloud or any other type of cloud. Computer system 101 may be part of cloud 120, or may be part of another cloud, or may be separate computer system that is not part of a cloud.

The node monitoring module 110 may send monitoring requests 111 to the cloud nodes 120 to determine whether the cloud nodes are running and are functioning correctly. These monitoring requests 111 may be sent on a regular basis, or as otherwise specified by a user (e.g. a network administrator or other user 105). The cloud nodes 120 may then respond to the monitoring requests 111 using a response message 112. This response message may indicate that the monitoring message 111 was received, and may further indicate the current operating state of the cloud nodes 120. The current operating state may indicate which software applications are running (including virtual machines (VMs)), which errors have occurred (if any) within a specified time frame, the amount of processing resources currently available (and currently being used), and any other indication of the node's state. The software applications (e.g. 116) may be running on computer system 101, or may be running on any of the other cloud nodes 120. Thus, in some cases, computer system 101 may be a management system that allows monitoring of other cloud nodes. Alternatively, computer system 101 may be configured to perform management operations as well as run software applications.

If it is determined that one or more of the cloud nodes 120 are not responding to the monitoring requests 111, are in an unrecoverable faulted state, or are responding with an indication that various errors are occurring, then node isolating module 115 may be implemented to isolate the unresponsive or problematic cloud node(s). As used herein, the term “isolate” refers to powering off, removing network connectivity, or otherwise making the cloud node ineffectual. As such, an isolated node's produced output is rendered ineffectual, as it is prevented from being transferred out in a way that can be used by end-users or other computers or software programs. A cloud node may be isolated in a variety of different manners, which will be described in greater detail below.

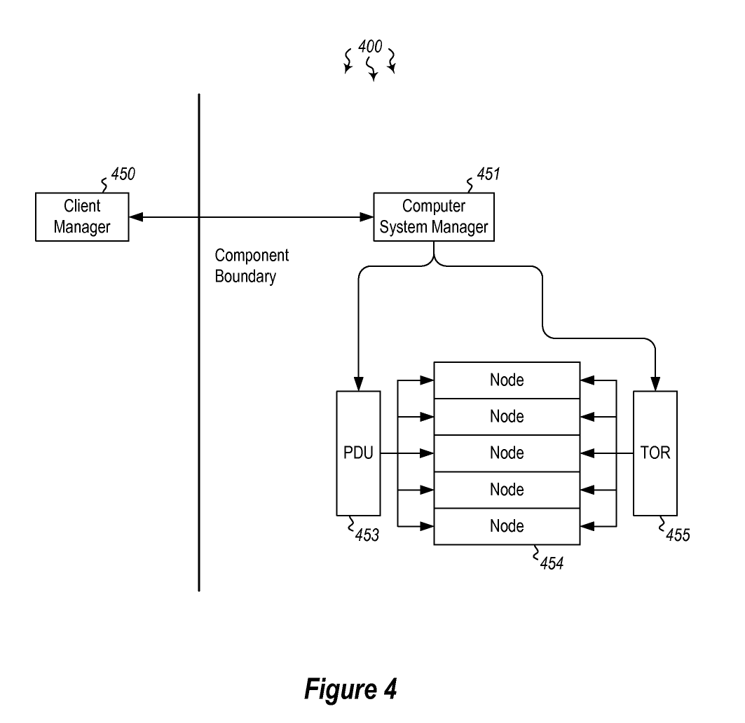

As shown in FIG. 4, a power distribution unit (PDU) 453 may be used to supply and regulate power to each of cloud nodes 454. The PDU may supply and regulate power to each node individually. The top of rack switch (TOR 455) may similarly control network connectivity for each of the cloud nodes 454 individually. Either or both of the PDU 453 and the TOR 455 may be used to isolate the cloud nodes 454. For example, the PDU may power down a node that is not responding to monitoring requests 111, or the TOR switch may disable the network port that a problematic node is using. A computer system manager (e.g. 451) may be used to issue node isolation commands, including sending specific commands to the TOR to shut off a given port or sending commands to the PDU to power down a specific node.

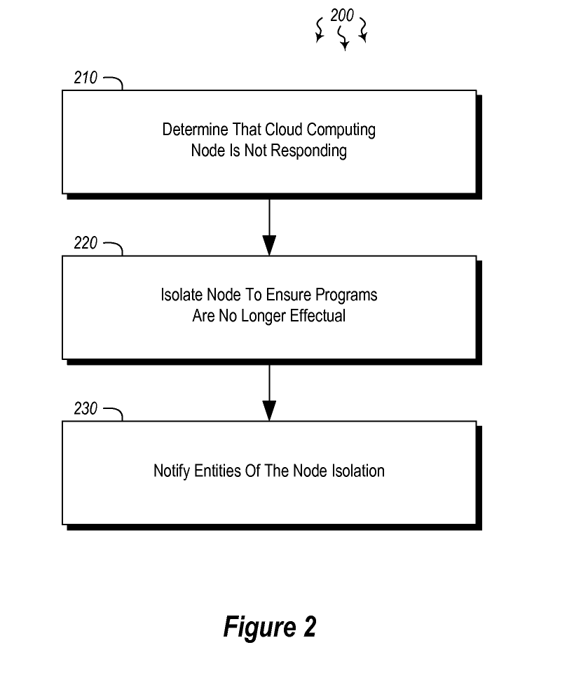

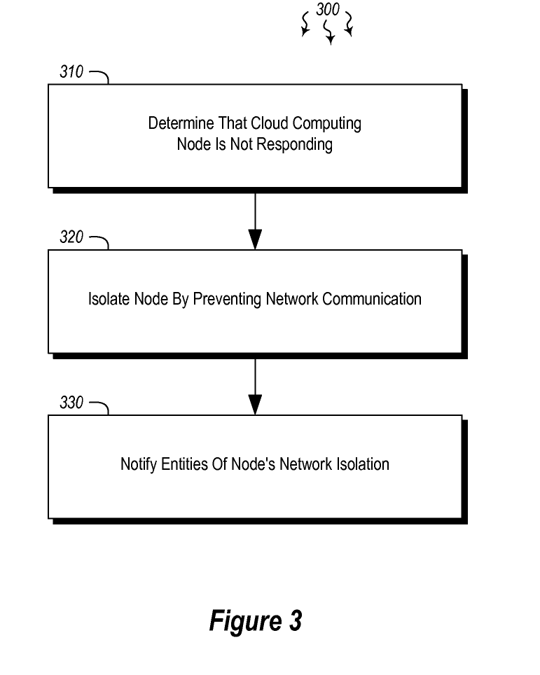

In some cases, policies may be established (e.g. policy 126 of FIG. 1) which dictate how and when nodes are isolated, and when those isolated nodes are to be brought back online. In some embodiments, the policy may be a declarative or “intent-based” policy in which a user (e.g. 105) or client manager 450 describes an intended result. The computer system manager 451 then performs the isolation in an appropriate manner according to the intent-based policy. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for isolating a cloud computing node. The method 200 will now be described with frequent reference to the components and data of environments 100 and 400 of FIGS. 1 and 4, respectively.

Method 200 includes an act of determining that a cloud computing node is no longer responding to monitoring requests (act 210). For example, node monitoring module 110 of computer system 101 may determine that one or more of cloud computing nodes 120 is not responding to monitoring requests 111. The monitoring requests may be sent out according to a polling schedule, or on a manual basis when requested by a user (e.g. request 106 from user 105). The monitoring requests 111 may request a simple functioning or not functioning status, or may request a more complex status that indicates errors or failures, indicates which software applications are currently running or have failed or are producing errors. As such, the monitoring requests 111 may request a variable amount of information from the cloud nodes. This information may be used to determine grey failures where the node still has power, but has lost network connectivity or has some type of software issue. In such cases, a node may still be responding to monitoring requests, but may be having other hardware or software problems.

Method 200 includes an act of isolating the determined cloud computing node to ensure that one or more software programs running on the determined cloud computing node are no longer effectual (act 220). Thus, node isolating module 115 may isolate any problematic or unresponsive cloud nodes. For instance, any nodes that fail to send a response message 112 back to the node monitoring module 110 may be isolated. Additionally or alternatively, any nodes that do respond, but are reporting errors in hardware or software may similarly be isolated by node isolating module 115. The isolation (117) ensures that software programs 116 (including VMs) running on that cloud node (e.g. 120) are no longer capable of producing outputs that could be used by other users or other software programs.

The isolation 117 may occur in a variety of different ways including powering down the determined cloud node. As diagrammed in FIG. 4, the computer system manager 451 may send an indication to power distribution unit (PDU 453) that at least one of the nodes 454 are to be isolated. In response, the PDU may individually power down the indicated nodes. The nodes may be powered down immediately, or after a software shutdown has been attempted. In some cases, any software applications running on the powered-down node may be re-instantiated on another node in that cloud or in another cloud using software program instantiation module 125. These applications may be re-instantiated according to a specified service model, which may, for example, indicate a certain number of software instances to instantiate on that node.

Isolating a cloud computing node to ensure that software programs running on the determined cloud computing node are no longer effectual may also include network-based isolation, as will be explained below with regard to method 300 of FIG. 3. The isolation 117 may further be accomplished by performing manual action on that node. For example, user 105 may unplug the power cord of the determined node. Alternatively, the user 105 may unplug a network cable, or manually disable a wired or wireless network adapter. Other manual steps may also be taken to ensure that a problematic node or software application is isolated from other applications, nodes and/or users.

As mentioned above, an intent-based cloud service may be used to isolate unresponsive or error-producing cloud computing nodes. The intent-based service may first determine why the node is to be isolated before the isolation is performed. It may, for example, determine that the cloud node or software application running on a particular node is part of a high-priority workflow. As such, a new instance may be instantiated before the problematic node is isolated. The intent-based service may designed to receive an indication of what is to be done (e.g. keep five instances running at all times, or prioritize this workflow over other workflows, or prevent this workflow from using more than twenty percent of the available network capacity). Substantially any user-described intent may be implemented by the intent-based cloud service. The computer system manager 451 may enforce the intent-based rules in the fastest or most reliable or cheapest way possible. Each node may thus be isolated in a different manner, if the computer system manager determines that that way is the most appropriate, based on the specified intent.

In some cases, applications that are re-instantiated on other nodes are only re-instantiated after isolation of the determined node has been confirmed. Moreover, if reliability or quality of service contracts are in place, isolation of the unresponsive or problematic node or application may be maintained for a specified period of time, or until the problem is fixed.

Isolating a specific cloud computing node to ensure that software programs running on the node are no longer effectual may further include controlling motherboard operations to prevent the software programs from communicating with other entities. For example, motherboard operations such as data transfers over a bus, data transfers to a network card, data processing or other operations may be terminated, postponed or otherwise altered so that the data is not processed and/or is not transmitted. As such, the node is effectively isolated from receiving data, processing data and/or transmitting data to other users, applications, cloud nodes or other entities.

Returning to FIG. 2, method 200 includes an act of notifying one or more entities that the determined cloud computing node has been isolated (act 230). For example, computer system 101 may notify one or more of cloud nodes 120 that the determined node has been isolated. The computer system may also notify other entities including user 101 and other cloud or other computing systems that communicate with the determined node. The notification may indicate the type of isolation (e.g. powering down, network, or other), as well as the planned extent of the isolation (e.g. one hour, one day, until fixed, indefinite, etc.). In some cases, the notification may be sent as a low-priority message, as the determined cloud computing node has been isolated and is no longer at risk of processing tasks while in a faulty state.

FIG. 3 illustrates a flowchart of a method 300 for isolating a cloud computing node using network-based isolation. The method 300 will now be described with frequent reference to the components and data of environment 100.

Method 300 includes an act of determining that a cloud computing node is no longer responding to monitoring requests (act 310). As explained above, computer system 101 may send monitoring requests 111 to any one or more of cloud nodes 120. If the cloud nodes do not return a response to the monitoring request 112, or if the response indicates that the cloud nodes are producing errors (either hardware or software errors), then the node may be designated as being in a faulty or unresponsive state.

Method 300 next includes an act of isolating the determined cloud computing node by preventing the determined cloud computing node from at least one of sending and receiving network data requests, the isolation ensuring that software programs running on the determined cloud computing node are no longer able to communicate with other computer systems (act 320). Thus, node isolating module 115 may isolate software programs 116 using a network-based isolation. The network-based isolation prevents data from being received and/or sent at the unresponsive or problematic node. In some cases, preventing data from being received or sent is implemented by deactivating network switch ports used by the determined cloud computing node for data communication. Thus, as shown in FIG. 4, one or more of the ports used by the top-of-rack switch (TOR 455) may be disabled for the nodes that use those ports. In another embodiment, the network-based isolation may be performed on a software level, where incoming or outbound data requests are stopped using a software-based firewall. After a given node has been isolated from the network, that node may be safely powered down by the power distribution unit (PDU 453).

Method 300 includes an act of notifying one or more entities with a notification that the determined cloud computing node has been isolated (act 330). Computer system 101 may notify user 105 (among other users), as well as other software applications and/or cloud computing nodes, that the determined node has been isolated in some fashion. The notification may also include a request that the determined, isolated cloud computing node be fixed, and may include a timeframe by which the node is to be fixed.

In some cases, when a node has been isolated, the computer system 101 (or specifically the computer system manager 451) may provide a guarantee to other nodes or components that the isolated node will remain isolated for at least a specified amount of time. Thus, for example, if a node was isolated by disabling the network port it was using, the network port would remain disabled until the node was powered off or was otherwise isolated. Once the node has been powered off (and is thus guaranteed to be isolated), the network port can be safely re-enabled.

Once the node has been isolated and/or powered down, one or more of the software applications or virtual machines may be re-instantiated (by module 125) on another computing system (including any of cloud nodes 120). The applications may be re-instantiated according to a policy 126 or according to a user-specified schedule. If it is determined, however, that the new node on which the applications are to be re-instantiated is unhealthy or is problematic, the re-instantiation of the applications on that node may be prevented, and may be re-attempted on another node. The number of re-instantiation retries may also be specified in the policy 126.

Accordingly, methods, systems and computer program products are provided which isolate a cloud computing node. Many different methods for isolating a node are described herein. Any of these methods may be used to isolate a node once it is determined that the node is unresponsive (e.g. due to hardware failure) or has become problematic in some fashion.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising the following:
one or more processors;
system memory;
one or more computer-readable storage media having stored thereon computer-executable instructions that, when executed by the one or more processors, causes the computing system to perform a method for isolating a cloud computing node, the method comprising the following:
an act of determining that a cloud computing node is no longer responding to monitoring requests;
an act of isolating the determined cloud computing node to ensure that one or more software programs running on the determined cloud computing node are no longer effectual; and
an act of notifying one or more entities that the determined cloud computing node has been isolated.

2. The computer system of claim 1, wherein isolating the determined cloud computing node to ensure that one or more software programs running on the determined cloud computing node are no longer effectual comprises powering down the determined cloud computing node.

3. The computer system of claim 2, further comprising an act of instantiating one or more of the software programs that were running on the determined cloud computing node on a second, different cloud computing node.

4. The computer system of claim 3, wherein the one or more software applications are instantiated on the second, different cloud computing node according to a specified service model.

5. The computer system of claim 1, wherein isolating the determined cloud computing node comprises preventing the determined cloud computing node from at least one of sending and receiving network data requests.

6. The computer system of claim 5, wherein preventing the determined cloud computing node from at least one of sending and receiving network data requests includes deactivating one or more network switch ports used by the determined cloud computing node for data communication.

7. The computer system of claim 1, wherein isolating the determined cloud computing node to ensure that one or more software programs running on the determined cloud computing node are no longer effectual comprises at least one manual action performed by a user.

8. The computer system of claim 1, wherein an intent-based cloud computing service is used to isolate the determined cloud computing node, wherein the intent-based cloud computing service guarantees, for at least a specified amount of time, that the isolated cloud computing node will not be restarted.

9. The computer system of claim 8, wherein the intent-based cloud computing service starts one or more of the isolated software applications after isolation of the determined cloud computing node has been confirmed.

10. The computer system of claim 1, wherein the determined cloud computing node is isolated according to a user-defined policy.

11. The method of claim 1, wherein isolating the determined cloud computing node to ensure that one or more software programs running on the determined cloud computing node are no longer effectual comprises controlling one or more motherboard operations to prevent the software programs from communicating with other entities.

12. The computer system of claim 1, wherein the notification is sent as a low-priority message due to determined cloud computing node being isolated.

13. A computer system comprising the following:
one or more processors;
system memory;
one or more computer-readable storage media having stored thereon computer-executable instructions that, when executed by the one or more processors, causes the computing system to perform a method for isolating a cloud computing node using network-based isolation, the method comprising the following:
an act of determining that a cloud computing node is no longer responding to monitoring requests;
an act of isolating the determined cloud computing node by preventing the determined cloud computing node from at least one of sending and receiving network data requests, the isolation ensuring that software programs running on the determined cloud computing node are no longer able to communicate with other entities outside of the determined cloud computing node; and
an act of notifying one or more entities with a notification that the determined cloud computing node has been isolated.

14. The computer system of claim 13, wherein isolating the determined cloud computing node comprises powering the determined node down after isolation from the network.

15. The computer system of claim 13, wherein the notification includes a request that the determined, isolated cloud computing node be fixed.

16. The computer system of claim 13, wherein preventing the determined cloud computing node from at least one of sending and receiving network data requests comprises deactivating one or more network switch ports used by the determined cloud computing node for data communication.

17. The computer system of claim 13, further comprising an act of receiving an instantiation request for one or more of the software programs that were running on the isolated, determined cloud computing node to be instantiated on a second, different cloud computing node.

18. The computer system of claim 17, wherein upon determining that the second, different cloud computing node is unhealthy, the second, different cloud computing node is prevented from instantiating the one or more software programs.

19. The computer system of claim 18, wherein one or more instantiation retries are attempted over a specified period of time.

20. A computer system comprising the following:
one or more processors;
system memory;
one or more computer-readable storage media having stored thereon computer-executable instructions that, when executed by the one or more processors, causes the computing system to perform a method for isolating a cloud computing node using network-based isolation, the method comprising the following:
an act of determining that a cloud computing node is no longer responding to monitoring requests;
an act of isolating the determined cloud computing node by preventing the determined cloud computing node from at least one of sending and receiving network data requests, the preventing including deactivating one or more network switch ports used by the determined cloud computing node for data communication, wherein isolation ensures that software programs running on the determined cloud computing node are no longer able to communicate with other computer systems; and
an act of notifying one or more entities with a notification that the determined cloud computing node has been isolated;
wherein isolating the determined cloud computing node comprises preventing the determined cloud computing node from at least one of sending and receiving network data requests, the preventing including deactivating one or more network switch ports used by the determined cloud computing node for data communication.
